(19) United States
(12) Patent Application Publication
(10) Pub. No.: US 2026/0238401 A1
(43) Pub. Date: Aug. 13, 2026

(54) METHOD AND APPARATUS FOR HYBRID AUTOMATIC REPEAT REQUEST-ACKNOWLEDGEMENT REPORT IN NON-TERRESTRIAL NETWORK COMMUNICATIONS

(71) Applicant: MediaTek Singapore Pte. Ltd., Singapore (SG)

(72) Inventors: Gilles CHARBIT, Cambridge (GB); Abdelkader MEDLES, Cambridge (GB); Wen-Jiunn LIU, Hsinchu City (TW)

(21) Appl. No.: 19/469,642

(22) PCT Filed: Apr. 2, 2024
(86) PCT No.: PCT/CN2024/085435

§ 371 Date: Sep. 26, 2025

Related U.S. Application Data
(60) Provisional application No. 63/494,482, filed on Apr. 6, 2023.

(51) Int. Cl. H04L 1/1867; H04L 5/00; H04W 72/11

(52) U.S. Cl. CPC H04L 1/1896; H04L 5/0044; H04W 72/11

(57) ABSTRACT

Solutions pertaining to enhanced hybrid automatic repeat request-acknowledgement (HARQ-ACK) report for a configured downlink reception in non-terrestrial network (NTN) communications. An apparatus implemented in a UE receives at least one configuration of offset value from a network node. The apparatus performs a downlink reception configured by the network node. The apparatus determines an offset value that is applicable at a slot overlapping with a last symbol of the downlink reception. The apparatus transmits HARQ information to the network node according to the offset value.

### CROSS REFERENCE TO RELATED PATENT APPLICATION(S)

The present disclosure is part of a non-provisional application claiming the priority benefit of U.S. Patent Application No. 63/494,482, filed 6 Apr. 2023, the content of which herein being incorporated by reference in its entirety.

### TECHNICAL FIELD

The present disclosure is generally related to mobile communications and, more particularly, to enhanced hybrid automatic repeat request-acknowledgement (HARQ-ACK) report for a configured downlink reception in non-terrestrial network (NTN) communications.

### BACKGROUND

Unless otherwise indicated herein, approaches described in this section are not prior art to the claims listed below and are not admitted as prior art by inclusion in this section.

In wireless communications, such as mobile communications under the 3^{rd} Generation Partnership Project (3GPP) standards including 5^{th} Generation (5G) New Radio (NR) and 4^{th} Generation (4G) Long-Term Evolution (LTE), hybrid automatic repeat request (HARQ) is a communication protocol that allows the sender to detect and correct errors in the transmitted data. When data is transmitted from the sender to the recipient, the recipient sends an acknowledgement (ACK) message to the sender indicating that the data has been received successfully. If the sender does not receive an ACK message within a certain period of time, it assumes that the data was not received correctly and sends the data again.

In NR, downlink (DL) configuration for a physical downlink shared channel (PDSCH) reception via a semi-persistent scheduling (SPS) is triggered via downlink control information (DCI). The HARQ-ACK report is indicated in the DCI activating the SPS PDSCH reception. For example, for an SPS PDSCH reception ending in DL slot n_{D}, the UE transmits the physical uplink control channel (PUCCH) in uplink (UL) slot n+k, where k is provided by the PDSCH-to-HARQ feedback timing indicator field, if present, in a DCI format activating the SPS PDSCH reception.

In NR NTN communications, K_{offset} is introduced to handle the long propagation delays in satellite systems. In satellite systems, each UE needs to apply a large timing advance (TA) value to compensate the round-trip time (RTT) between UE and 5G Node B (gNB)/satellite. When TA becomes large, the cardinality of the set of values of k that can be used is reduced significantly. To resolve this issue, the scheduling offset K_{offset} is introduced to enhance the transmission timing including the transmission timing of HARQ-ACK on the PUCCH. However, the value of K_{offset} could be changed/updated dynamically via a control signaling. The UE may receive a new K_{offset} value while preparing the HARQ-ACK report for the scheduled downlink reception. It is not clear which K_{offset} value should be applied for transmitting the HARQ-ACK report.

There exists ambiguity in determining transmission time for uplink transmissions when the K_{offset} value is changed. Accordingly, how to resolve the ambiguity becomes an important issue in the newly developed wireless communication network. Therefore, there is a need to provide proper schemes to enhance HARQ-ACT report in NTN communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues. More specifically, various schemes proposed in the present disclosure pertain to enhanced HARQ-ACK report for a configured downlink reception in NTN communications.

In one aspect, a method may involve a UE receiving at least one configuration of offset value from a network node. The method may also involve the UE performing a downlink reception configured by the network node. The method may further involve the UE determining an offset value that is applicable at a slot overlapping with a last symbol of the downlink reception. The method may further involve the UE transmitting HARQ information to the network node according to the offset value.

In another aspect, an apparatus may comprise a transceiver which, during operation, wirelessly communicates with at least one network node. The apparatus may also comprise a processor communicatively coupled to the transceiver. The processor, during operation, may perform operations comprising receiving, via the transceiver, at least one configuration of offset value from the network node. The processor may also perform operations comprising performing a downlink reception configured by the network node. The processor may further perform operations comprising determining an offset value that is applicable at a slot overlapping with a last symbol of the downlink reception. The processor may further perform operations comprising transmitting, via the transceiver, HARQ information to the network node according to the offset value.

It is noteworthy that, although description provided herein may be in the context of certain radio access technologies, networks and network topologies such as and NTN, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, 5th Generation (5G), New Radio (NR), Internet-of-Things (IoT), Narrow Band Internet of Things (NB-IoT), Industrial Internet of Things (IIoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 is a diagram of an example scenario under a proposed scheme in accordance with the present disclosure.

FIG. 3 is a block diagram of an example communication system in accordance with an implementation of the present disclosure.

FIG. 4 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to HARQ-ACK report for a configured downlink reception in NTN communications. According to the present disclosure, a number of possible solutions may be implemented separately or jointly. That is, although these possible solutions may be described below separately, two or more of these possible solutions may be implemented in one combination or another.

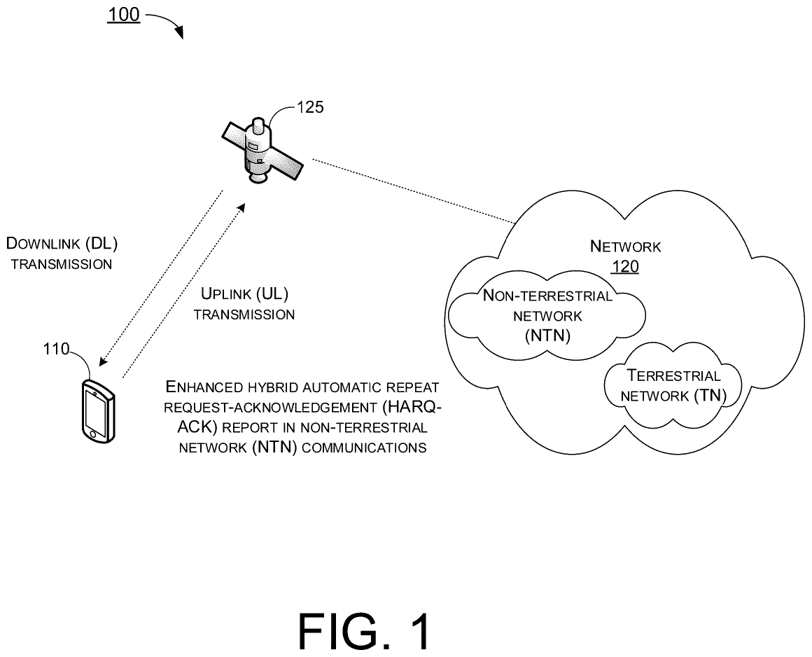

FIG. 1 illustrates an example network environment 100 in which various proposed schemes in accordance with the present disclosure may be implemented. Network environment 100 may involve a UE 110 and a wireless network 120 (e.g., an LTE network, a 5G/NR network, an IoT/NB-IoT/IIoT network, a 6G network and/or an NTN network). UE 110 may communicate with wireless network 120 via a network node 125. In some cases, network node 125 may be an NT network node (e.g., a satellite) of an NTN. In some cases, network node 125 may be a terrestrial network node (e.g., a base station such as a gNB, eNB or transmission/reception point (TRP)). In some cases, the UE 110 may be an IoT device such as a narrow band (NB)-IoT UE or an enhanced machine type communication (eMTC) UE (e.g., a bandwidth reduced low complexity (BL) UE or a coverage enhancement (CE) UE). Each of UE 110 and network node 125 may be configured to perform operations pertaining to enhanced HARQ-ACK report for a configured downlink reception in NTN communications under various proposed schemes in accordance with the present disclosure, as described below.

In Release-17 NR NTN, there were agreements for SPS PDSCH, and for UE-specific K_{offset} valid at the slot of the associated DCI being received is applied. For DCI scheduled physical uplink shared channel (PUSCH) including channel state information (CSI) on PUSCH and aperiodic sounding reference signal (SRS) and for HARQ-ACK on PUCCH, the UE-specific K_{offset} valid at the slot of the associated DCI being received is applied. The agreements for K_{offset} in Release-17 NR NTN apply generally to the DCI with Downlink Assignment Index (DAI) for DL PDSCH and report of HARQ-ACK for the DL PDSCH on PUCCH. There may be ambiguity in case the parameter K_{offset} is changed via medium access control (MAC) control element (CE) UE-specific K_{offset} after the trigger for SPS PDSCH reception via DCI, as there is no trigger for subsequent SPS PDSCH until the trigger for SPS PDSCH release is received via DCI.

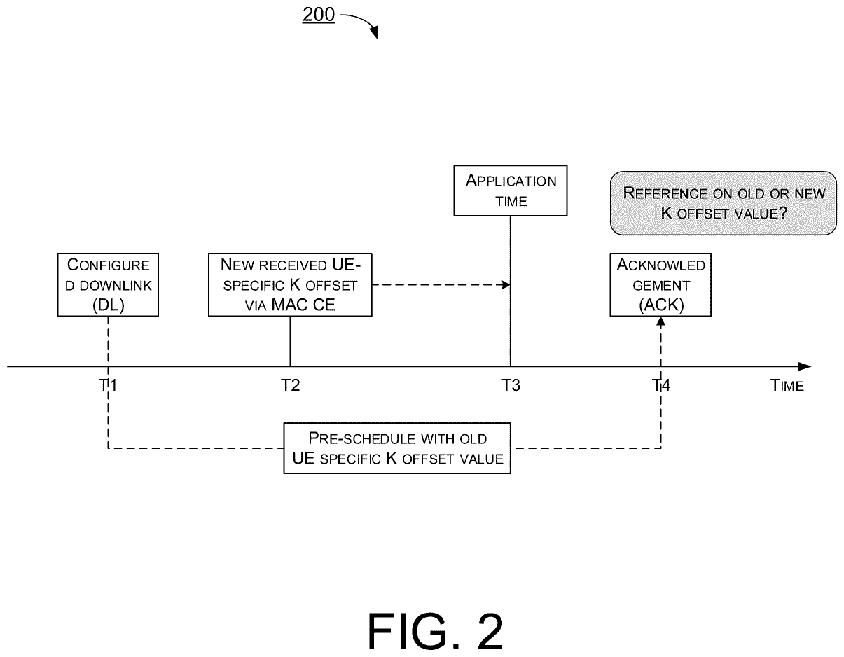

FIG. 2 illustrates an example scenario 200 under schemes in accordance with implementations of the present disclosure. Scenario 200 involves at least a UE and a network node/satellite, which may be a part of a wireless communication network (e.g., an LTE network, a 5G/NR network, an IoT/NB-IoT/IIoT network, a 6G network and/or an NTN network). Scenario 100 illustrates the HARQ-ACK reporting timeline. The UE may receive a DCI scheduling a configured downlink reception at T1. The UE may determine the timing (e.g., t4) to transmit the HARQ-ACK report for the configured downlink reception according to a pre-scheduled old UE-specific K_{offset} value. The UE may further receive a new UE-specific K_{offset} value via a MAC CE message at T2. The new UE-specific K_{offset} value is specified with an application time at T3 which is before the transmission time (e.g., T4) of the HARQ-ACK report. Under such scenario, there exists ambiguity that which K_{offset} value should be applied for determining the transmission time of the HARQ-ACK report. It is not clear whether the UE should refer to the old UE-specific K_{offset} value or should refer to the new UE-specific K_{offset} value for determining the transmission time of the HARQ-ACK report.

In view of the above, the present disclosure proposes some schemes pertaining to determining the transmitting time of HARQ-ACK report for a configured downlink reception with respect to UE and network apparatus in mobile/NTN communications. According to the schemes of the present disclosure, the UE may receive at least one configuration of offset value from the network node (e.g., satellite/base station). The UE may perform a downlink reception configured by the network node. The UE may determine an offset value that is applicable at a slot overlapping with a last symbol of the downlink reception. Then, the UE may transmit HARQ information to the network node according to the offset value.

Specifically, the UE may receive a first configuration of a first offset value (e.g., old K_{offset} value) before the downlink reception. The UE may further receive a second configuration of a second offset value (e.g., new K_{offset} value) after the downlink reception and before the transmitting of the HARQ information. The UE may determine that the first offset value (i.e., old K_{offset} value) is the offset value that is applicable at the slot overlapping with the last symbol of the downlink reception. Then, the UE may determine the transmission time of the HARQ information based on the first offset value (i.e., old K_{offset} value).

In some implementations, the second offset value (e.g., new K_{offset} value) may be provided/received via a MAC CE message. The configured downlink reception may be scheduled by a DCI. The configured downlink reception may comprise a SPS PDSCH reception.

In some implementations, the application/activation time of the second offset value (e.g., new K_{offset} value) starts before the transmitting of the HARQ information.

In some implementations, the offset value comprises a cell specific K offset value or a UE specific K offset value. The offset value is a scheduling offset for HARQ-ACK report of DL SPS PDSCH reception.

In some implementations, the HARQ information may be transmitted on a PUCCH or a PUSCH. The HARQ information may comprises a HARQ-ACK or a HARQ-negative ACK (HARQ-NACK).

In some implementations, the UE may determine a slot for transmitting the HARQ information according to the offset value.

In some implementations, the offset value may be provided in a DCI format activating the downlink reception.

In some implementations, the offset value may be configured for NTN communications.

In view of the schemes in accordance with implementations of the present disclosure, the UE procedure for reporting control information may be specified as follows. If a UE is provided K_{cell,offset} by cellSpecificKoffset or K_{UE,offset} by a MAC CE command, reference to a slot n+k for a PUCCH transmission or PUSCH transmission corresponds to a slot

$$n + k + {2}^{μ - {μ}_{{K}_{offset}}} \cdot {K}_{offset}$$

for the PUSCH or the PUCCH transmission, and reference to a slot n_{U}−K_{1,k} corresponds to slot

$${n}_{U} - {K}_{1 , k} - {2}^{μ - {μ}_{{K}_{offset}}} \cdot {K}_{offset} ,$$

where μ is the SCS configuration for the PUCCH transmission or PUSCH transmission, K_{offset} is defined (e.g., K_{offset}=K_{cell,offset}−K_{UE,offset}, where K_{cell,offset} is provided by cellSpecificKoffset and K_{UE,offset} is provided by a differential K_{offset} MAC CE command; otherwise, if not respectively provided, K_{cell,offset}=0 or K_{UE,offset}=0), and μ_{K}_{_{offset}}=0 in FR1. If cellSpecificKoffset or if the MAC CE command is not provided, K_{cell,offset}=0 or K_{UE,offset}=0, respectively. If the PUCCH or PUSCH transmission is scheduled by a DCI format, the value of K_{UE,offset} is the one that is applicable at the slot overlapping with the last symbol of the PDCCH reception providing the DCI format. For PUCCH with HARQ-ACK information for SPS PDSCH reception, the value of K_{UE,offset} is the one that is applicable at the slot overlapping with the last symbol of the SPS PDSCH reception. If the PUCCH transmission or the PUSCH transmission is scheduled by a DCI format with CRC scrambled by TC-RNTI, K_{UE,offset}=0. If the UE is provided a K_{UE,offset} value by a MAC CE command, the UE applies the MAC CE command in the first slot that is after slot

$$k + 3 {N}_{slot}^{subframe , μ}$$

where k is the slot where the UE would transmit a PUCCH with HARQ-ACK information for the PDSCH providing the MAC CE command, y is the SCS configuration for the PUCCH transmission that is determined in the slot when the MAC CE command is applied.

Accordingly, the offset value for determining the transmission time of HARQ information can be clearly specified. The UE is able to determine a correct offset value for transmitting HARQ information even when the offset value is updated/changed. Thus, the ambiguity at UEs can be avoided and the performance of HARQ report transmission can be improved.

### Illustrative Implementations

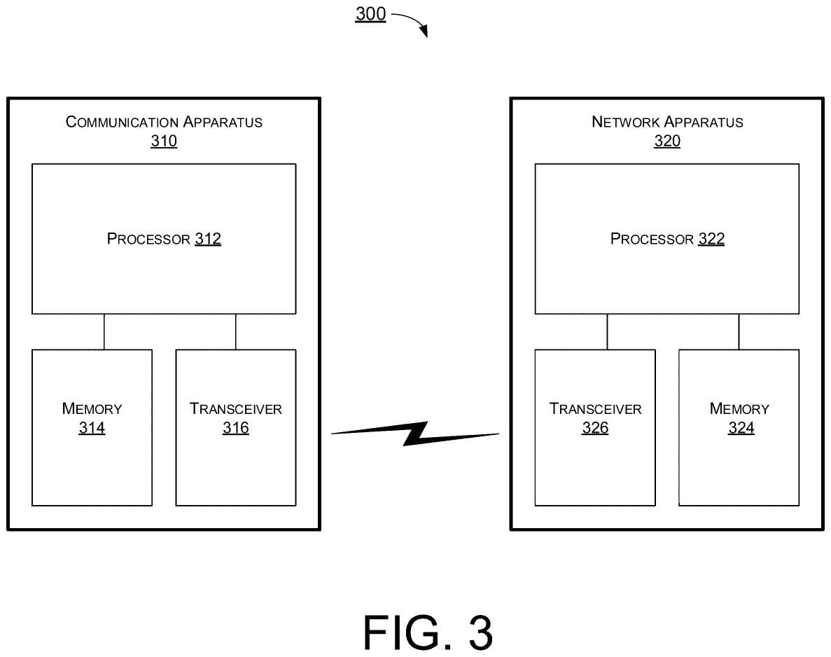

FIG. 3 illustrates an example communication system 300 having an example communication apparatus 310 and an example network apparatus 320 in accordance with an implementation of the present disclosure. Each of communication apparatus 310 and network apparatus 320 may perform various functions to implement schemes, techniques, processes and methods described herein pertaining to enhanced HARQ-ACK report for a configured downlink reception in NTN communications, including scenarios/schemes described above as well as process(es) described below.

Communication apparatus 310 may be a part of an electronic apparatus, which may be a UE such as a portable or mobile apparatus, a wearable apparatus, a wireless communication apparatus or a computing apparatus. For instance, communication apparatus 310 may be implemented in a smartphone, a smartwatch, a personal digital assistant, a digital camera, or a computing equipment such as a tablet computer, a laptop computer or a notebook computer. Communication apparatus 310 may also be a part of a machine type apparatus, which may be an IoT, NB-IoT, IIoT or NTN apparatus such as an immobile or a stationary apparatus, a home apparatus, a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 310 may include at least some of those components shown in FIG. 3 such as a processor 312, for example. Communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a part of an electronic apparatus/station, which may be a network node such as a base station, a small cell, a router, a gateway or a satellite. For instance, network apparatus 320 may be implemented in an eNodeB in an LTE, in a gNB in a 5G, NR, IoT, NB-IoT, IIoT, or in a satellite in an NTN network. Alternatively, network apparatus 320 may be implemented in the form of one or more IC chips such as, for example and without limitation, one or more single-core processors, one or more multi-core processors, or one or more RISC or CISC processors. Network apparatus 320 may include at least some of those components shown in FIG. 3 such as a processor 322, for example. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of processor 312 and processor 322 may be implemented in the form of one or more single-core processors, one or more multi-core processors, one or more RISC processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including enhanced HARQ-ACK report for a configured downlink reception in NTN communications in accordance with various implementations of the present disclosure.

In some implementations, communication apparatus 310 may also include a transceiver 316 coupled to processor 312 and capable of wirelessly transmitting and receiving data. In some implementations, communication apparatus 310 may further include a memory 314 coupled to processor 312 and capable of being accessed by processor 312 and storing data therein. In some implementations, network apparatus 320 may also include a transceiver 326 coupled to processor 322 and capable of wirelessly transmitting and receiving data. In some implementations, network apparatus 320 may further include a memory 324 coupled to processor 322 and capable of being accessed by processor 322 and storing data therein. Accordingly, communication apparatus 310 and network apparatus 320 may wirelessly communicate with each other via transceiver 316 and transceiver 326, respectively.

Each of communication apparatus 3410 and network apparatus 320 may be a communication entity capable of communicating with each other using various proposed schemes in accordance with the present disclosure. To aid better understanding, the following description of the operations, functionalities and capabilities of each of communication apparatus 310 and network apparatus 320 is provided in the context of a mobile communication environment in which communication apparatus 310 is implemented in or as a communication apparatus or a UE (e.g., UE 110) and network apparatus 320 is implemented in or as a network node or base station (e.g., network node 125) of a communication network (e.g., network 120). It is also noteworthy that, although the example implementations described below are provided in the context of NTN, the same may be implemented in other types of networks.

Under some proposed schemes pertaining to enhanced HARQ-ACK report for a configured downlink reception in NTN communications in accordance with the present disclosure, with communication apparatus 310 implemented in or as UE 110 and network apparatus 320 implemented in or as network node 125 in network environment 100, processor 312 may receiving, via transceiver 316, at least one configuration of offset value from network apparatus 320. Processor 312 may perform a downlink reception configured by network apparatus 320. Processor 312 may further determine an offset value that is applicable at a slot overlapping with a last symbol of the downlink reception. Then, processor 312 may transmit, via transceiver 316, HARQ information to network apparatus 320 according to the offset value.

In some implementations, processor 312 may receive, via transceiver 316, a first configuration of a first offset value before the downlink reception. Processor 312 may further receive, via transceiver 316, a second configuration of a second offset value after the downlink reception and before the transmitting of the HARQ information. Then, processor 312 may determine that the first offset value is the offset value that is applicable at the slot overlapping with the last symbol of the downlink reception.

In some implementations, the second offset value may be received via a MAC CE.

In some implementations, an application time of the second offset value may start before the transmitting of the HARQ information.

In some implementations, the offset value may comprise a cell specific K offset value or a UE specific K offset value.

In some implementations, the downlink reception may comprise an SPS PDSCH reception.

In some implementations, processor 312 may transmit, via transceiver 316, the HARQ information on a PUCCH or a PUSCH.

In some implementations, processor 312 may determine a slot for transmitting the HARQ information according to the offset value.

In some implementations, the offset value may be provided in a DCI format activating the downlink reception.

In some implementations, the offset value may be configured for an NTN communication.

### Illustrative Processes

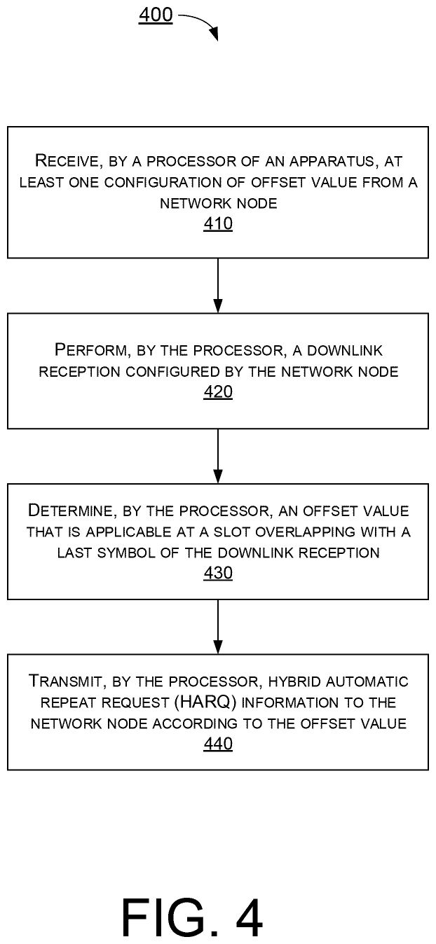

FIG. 4 illustrates an example process 400 in accordance with an implementation of the present disclosure. Process 400 may be an example implementation of schemes described above whether partially or completely, with respect to enhanced HARQ-ACK report for a configured downlink reception in NTN communications in accordance with the present disclosure.

Process 400 may represent an aspect of implementation of features of communication apparatus 310 and/or network apparatus 320. Process 400 may include one or more operations, actions, or functions as illustrated by one or more of blocks 410, 420, 430 and 440. Although illustrated as discrete blocks, various blocks of process 400 may be divided into additional blocks, combined into fewer blocks, or eliminated, depending on the desired implementation. Moreover, the blocks of process 400 may executed in the order shown in FIG. 4 or, alternatively, in a different order. Process 400 may be implemented by communication apparatus 310 or any suitable UE or machine type devices. Solely for illustrative purposes and without limitation, process 400 is described below in the context of communication apparatus 310 implemented in or as UE 110 and network apparatus 320 implemented in or as network node 125. Process 400 may begin at block 410.

At 410, process 400 may involve processor 312 of apparatus 310 receiving at least one configuration of offset value from a network node.

Process 400 may proceed from 410 to 420.

At 420, process 400 may involve processor 312 performing a downlink reception configured by the network node. Process 400 may proceed from 420 to 430.

At 430, process 400 may involve processor 312 determining an offset value that is applicable at a slot overlapping with a last symbol of the downlink reception. Process 400 may proceed from 430 to 440.

At 440, process 400 may involve processor 312 transmitting HARQ information to the network node according to the offset value.

In some implementations, process 400 may involve processor 312 receiving a first configuration of a first offset value before the downlink reception. Process 400 may also involve processor 312 receiving a second configuration of a second offset value after the downlink reception and before the transmitting of the HARQ information. Process 400 may further involve processor 312 determining that the first offset value is the offset value that is applicable at the slot overlapping with the last symbol of the downlink reception.

In some implementations, process 400 may involve processor 312 receiving the second offset value via a MAC CE.

In some implementations, an application time of the second offset value may start before the transmitting of the HARQ information.

In some implementations, the offset value may comprise a cell specific K offset value or a UE specific K offset value.

In some implementations, the downlink reception may comprise an SPS PDSCH reception.

In some implementations, process 400 may involve processor 312 transmitting the HARQ information on a PUCCH or a PUSCH.

In some implementations, process 400 may involve processor 312 determining a slot for transmitting the HARQ information according to the offset value.

In some implementations, process 400 may involve processor 312 obtaining the offset value in a DCI format activating the downlink reception.

In some implementations, the offset value may be configured for an NTN communication.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, at least one configuration of offset value from a network node;
performing, by the processor, a downlink reception configured by the network node;
determining, by the processor, an offset value that is applicable at a slot overlapping with a last symbol of the downlink reception; and
transmitting, by the processor, hybrid automatic repeat request (HARQ) information to the network node according to the offset value.

2. The method of claim 1, wherein the receiving of the at least one configuration of offset value comprises:
receiving, by the processor, a first configuration of a first offset value before the downlink reception; and
receiving, by the processor, a second configuration of a second offset value after the downlink reception and before the transmitting of the HARQ information, and
wherein the determining of the offset value comprises:
determining, by the processor, that the first offset value is the offset value that is applicable at the slot overlapping with the last symbol of the downlink reception.

3. The method of claim 2, wherein the second offset value is received via a medium access control (MAC) control element (CE).

4. The method of claim 2, wherein an application time of the second offset value starts before the transmitting of the HARQ information.

5. The method of claim 1, wherein the offset value comprises a cell specific K offset value or a user equipment (UE) specific K offset value.

6. The method of claim 1, wherein the downlink reception comprises a semi-persistent scheduling (SPS) physical downlink shared channel (PDSCH) reception.

7. The method of claim 1, wherein the HARQ information is transmitted on a physical uplink control channel (PUCCH) or a physical uplink shared channel (PUSCH).

8. The method of claim 1, further comprising:
determining, by the processor, a slot for transmitting the HARQ information according to the offset value.

9. The method of claim 1, wherein the offset value is provided in a downlink control information (DCI) format activating the downlink reception.

10. The method of claim 1, wherein the offset value is configured for a non-terrestrial network (NTN) communication.

11. An apparatus, comprising:
a transceiver which, during operation, wirelessly communicates with at least one network node; and
a processor communicatively coupled to the transceiver such that, during operation, the processor performs operations comprising:
receiving, via the transceiver, at least one configuration of offset value from the network node;
performing a downlink reception configured by the network node;
determining an offset value that is applicable at a slot overlapping with a last symbol of the downlink reception; and
transmitting, via the transceiver, hybrid automatic repeat request (HARQ) information to the network node according to the offset value.

12. The apparatus of claim 11, wherein, during operation, the processor further performs operations comprising:
receiving, via the transceiver, a first configuration of a first offset value before the downlink reception; and
receiving, via the transceiver, a second configuration of a second offset value after the downlink reception and before the transmitting of the HARQ information, and
wherein, in determining the offset value, the processor further performs operations comprising:
determining that the first offset value is the offset value that is applicable at the slot overlapping with the last symbol of the downlink reception.

13. The apparatus of claim 12, wherein the second offset value is received via a medium access control (MAC) control element (CE).

14. The apparatus of claim 12, wherein an application time of the second offset value starts before the transmitting of the HARQ information.

15. The apparatus of claim 11, wherein the offset value comprises a cell specific K offset value or a user equipment (UE) specific K offset value.

16. The apparatus of claim 11, wherein the downlink reception comprises a semi-persistent scheduling (SPS) physical downlink shared channel (PDSCH) reception.

17. The apparatus of claim 11, wherein the HARQ information is transmitted on a physical uplink control channel (PUCCH) or a physical uplink shared channel (PUSCH).

18. The apparatus of claim 11, wherein, during operation, the processor further performs operations comprising:
determining a slot for transmitting the HARQ information according to the offset value.

19. The apparatus of claim 11, wherein the offset value is provided in a downlink control information (DCI) format activating the downlink reception.

20. The apparatus of claim 11, wherein the offset value is configured for a non-terrestrial network (NTN) communication.
